(19) United States
(12) Patent Application Publication
(10) Pub. No.: US 2003/0027724 A1
(43) Pub. Date: Feb. 6, 2003

(54) Phase shift device in superconductor logic

(75) Inventors: Geordie Rose, Vancouver (CA); Mohammad H. S. Amin, Vancouver (CA); Timothy Lee Duty, Vancouver (CA); Alexandre Zagoskin, Vancouver (CA); Alexander N. Omelyanchouk, Kharkov (UA); Jeremy P. Hilton, Vancouver (CA)

Correspondence Address: Gary S. Williams, Pennie & Edmonds LLP, 3300 Hillview Avenue, Palo Alto, CA, 94304, US

(73) Assignee: D-Wave Systems, Inc.

(21) Appl. No.: 10/032,157

(22) Filed: Dec. 21, 2001

Related U.S. Application Data
(60) Provisional application No. 60/257,624, filed on Dec. 22, 2000.
(60) Provisional application No. 60/325,719, filed on Sep. 28, 2001.

(51) Int. Cl. H01P 1/00; H01B 1/00

(52) U.S. Cl. 505/210; 505/700; 333/161

(57) ABSTRACT

In accordance with the present invention, a superconducting phase shift device is presented. The phase shift device can introduce a phase shift between the phases of the order parameters of the device's two terminals. The two terminals can be coupled through an anisotropic superconductor with angled sides, or through two anisotropic superconductors with misaligned phases, or through a ferromagnet in the junction area. The phase shift device can be used in superconducting quantum computing circuitry. A method of fabricating the phase shift device with a technology different from fabrication technology of conventional superconducting materials is described. A method for fabricating a phase shifter chip including an array of phase shift devices is described.

### CROSS REFERENCE TO RELATED APPLICATIONS

The present application is related to U.S. provisional application serial No. 60/257,624, “Intrinsic phase shift device as an element of a qubit,” by Geordie Rose Mohammad H. S. Amin, Timothy Duty, Alexandre Zagoskin, and Alexander Omelyanchouk, filed Dec. 22, 2000, from which priority is being claimed, and to U.S. provisional application serial No. 60/325,719: “Phase Shift Device in Superconductor Logic,” by Alexey V. Ustinov and Jeremy P. Hilton, filed Sep. 28th, 2001, from which priority is being claimed, both provisional patent applications included herein by reference in their entirety.

### BACKGROUND

1. Field of the Invention

The invention relates to the field of superconducting quantum computing.

2. Description of Related Art

Quantum computers are built by a revolutionary new technology, promising much improved computational performance. Recent proposals for superconducting quantum computing systems have become the most promising technologies in terms of scalability and control.

The fundamental building block of a quantum computer is the quantum bit or qubit. The qubit can have two basis states, |0> and |1>, just like a bit in classical computing. During computation, however, there is no classical computing analogy as the state of the qubit becomes a quantum superposition of its basis states, and evolves according to the rules of quantum mechanics. Details on how quantum information processing works are well known, see, e.g., D. DiVincenzo, “The Physical Implementation of Quantum Computers”, p. 1, S. Braunstein and H. Lo, “Scalable Quantum Computers”, Wiley-VCH, Berlin, Germany, 2001, incorporated in its entirety by reference.

Quantum computers, based on superconducting technology, often rely on devices containing Josephson junctions.

Josephson junctions can be used to connect two superconducting terminals, which can belong to a superconducting loop or to a more extensive circuitry. The superconducting terminals have a complex order parameter, describing their superconducting state. The complex order parameter can be represented in terms of its amplitude and its phase. A Josephson junction can induce a difference between the phases of the two terminals of the Josephson junction, and junctions are often referred to according to this phase difference. For example, Josephson junctions that induce a π/2 phase difference are referred to as π/2-Josephson junctions, or π/2-junctions.

Some implementations of a flux qubit involve a micrometer-sized loop with three or four Josephson junctions, as described by J. E. Mooij, T. P. Orlando, L. Levitov, L. Tian, C. H. van der Wal, and S. Lloyd in “Josephson Persistent-Current Qubit,” Science vol. 285, p. 1036 (1999) and references therein, which is herein incorporated by reference in its entirety. The basis states of this system differ in the amounts of magnetic flux threading the loop. Application of a static magnetic field normal to the loop may bring the energy of two of these basis states into degeneracy. The application of static magnetic fields reduces the scalability and usefulness of the device. In particular, it introduces a dissipative coupling between the qubit and its environment, eventually leading to the loss of phase coherence between the superpositioned basis states.

Another proposal for a superconducting qubit includes two superconducting materials, one having an isotropic order parameter and another having an anisotropic order parameter, as described by L. loffe, V. Geshkenbein, M. Feigel'man, A. Fauchere, and G. Blatter in “Environmentally decoupled s-wave-d-wave-s-wave Josephson junctions for quantum computing,” Nature, vol. 398, p. 678 (1999), and the references therein, which is herein incorporated by reference in its entirety. This paper teaches a π-loop as a mechanism for isolating a flux qubit from the environment. The device has a complex design, and in particular it involves several Josephson junctions between conventional and unconventional superconducting materials, thus having limited scalability and reproducibility.

Therefore, there is a need for a superconducting qubit device that is conveniently scalable and reproducible, and has a minimal dissipation due to environmental coupling.

### SUMMARY OF THE INVENTION

In accordance with the present invention, a superconducting phase shift device is presented. An embodiment of the invention can introduce a phase shift α between the phases of the order parameters of the junction's two superconducting terminals. α can assume values between −π and π.

Such a phase shift device can be used in any type of superconducting quantum computing system. For example, a phase shift device can be useful in fabricating a flux quantum bit, or qubit. An example of a qubit is a superconducting loop with Josephson junctions, where the phase shift device can self-bias the loop to create a doubly degenerate a ground state, the two degenerate ground states distinguished by supercurrents flowing in the opposite directions. The two degenerate ground states can be used as the basis states of the qubit and therefore the superconducting loop can be used for quantum computing.

In accordance with the invention, a phase shift device can be fabricated using a method, different from the method used for fabricating the surrounding superconducting circuitry. In some embodiments the phase shift device can be fabricated on a substrate and subsequently insulated such that conventional superconducting circuitry can be fabricated in a layer overlying the phase shift device, connecting to the phase shift device where necessary. Alternately, a conventional superconducting circuitry layer can be fabricated on a substrate, subsequently insulated, and the phase shift device can then be fabricated overlying the conventional superconducting circuitry layer, connected to the circuitry. In some embodiments a phase shift device can be fabricated in the same layer as the superconducting circuitry.

### BRIEF DESCRIPTION OF THE FIGURES

FIGS. 1A-1G illustrate embodiments of phase shift devices.

FIG. 2 illustrates an embodiment of a qubit that includes a phase shift device.

FIG. 3 illustrates an act of fabricating a phase shift device.

FIG. 4 illustrates an act of fabricating a phase shift device.

FIG. 5 illustrates an act of fabricating a phase shift device.

FIGS. 6A-6C illustrate acts of fabricating a phase shifter chip including an N×M array of phase shift devices.

### DETAILED DESCRIPTION

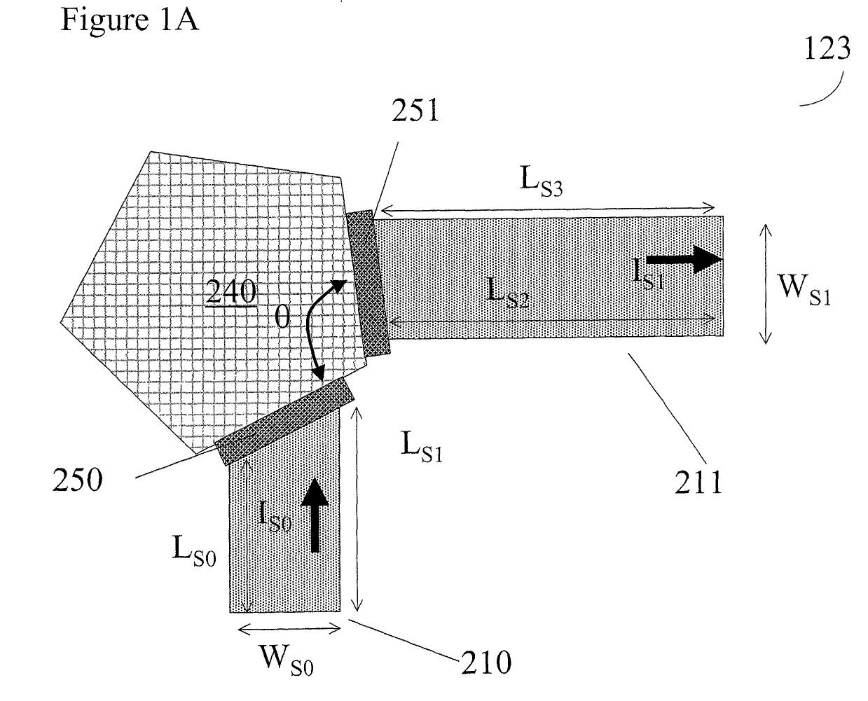

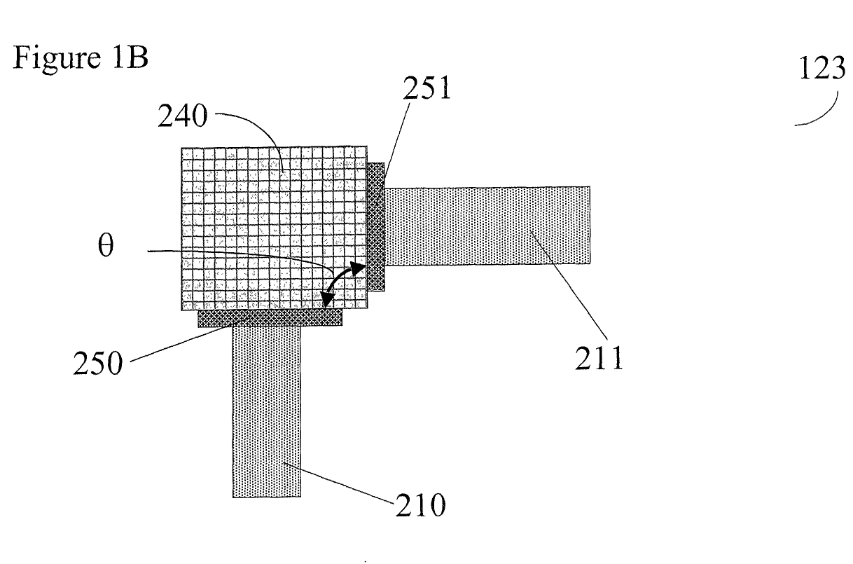

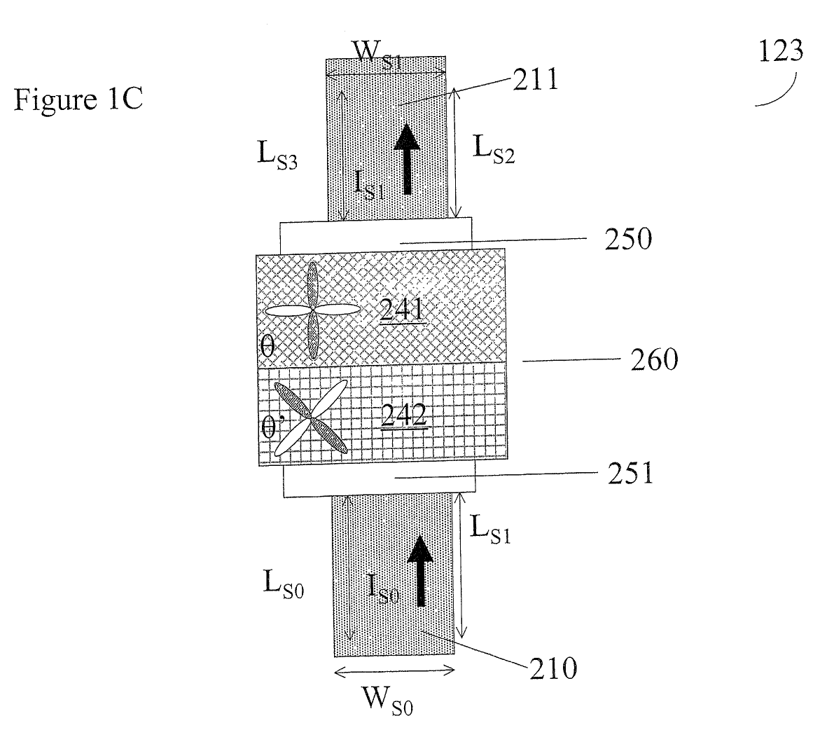

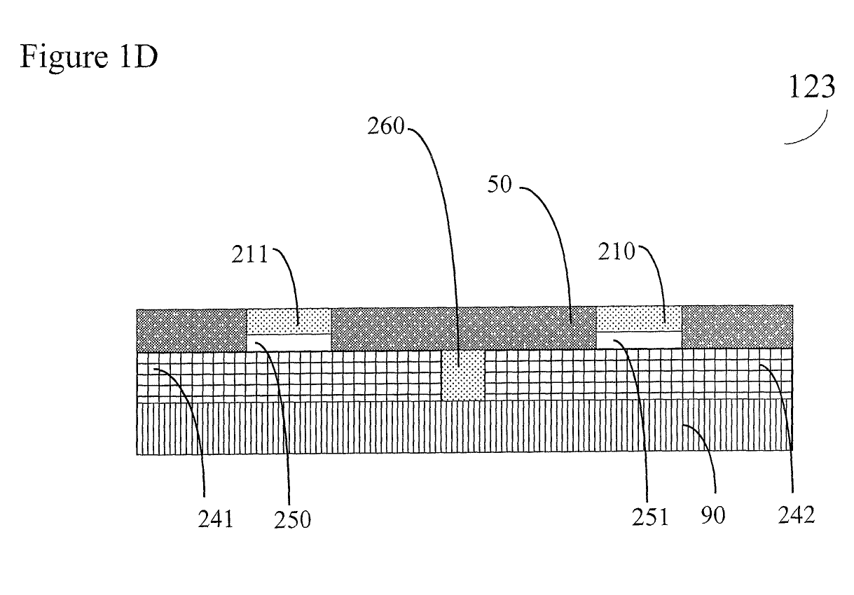

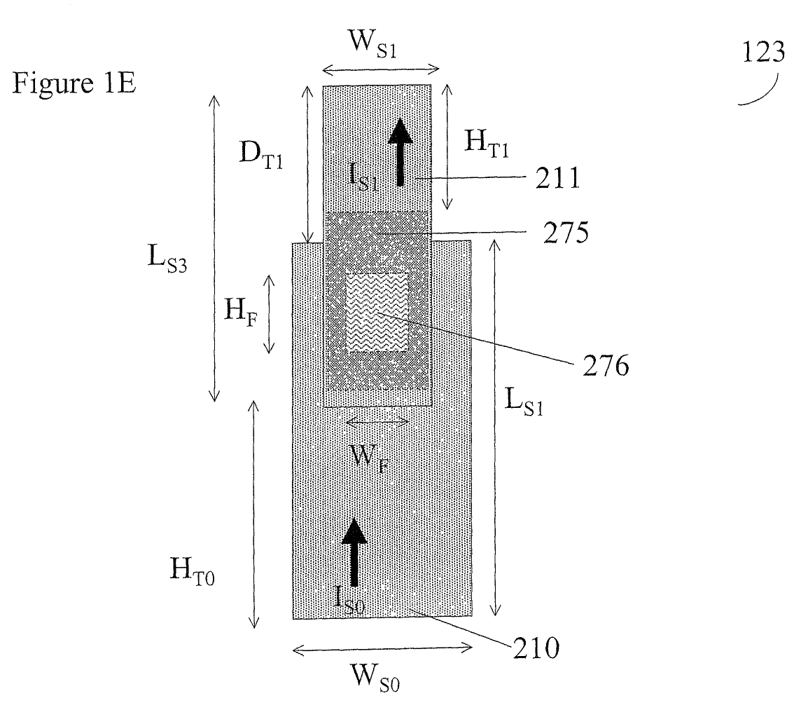

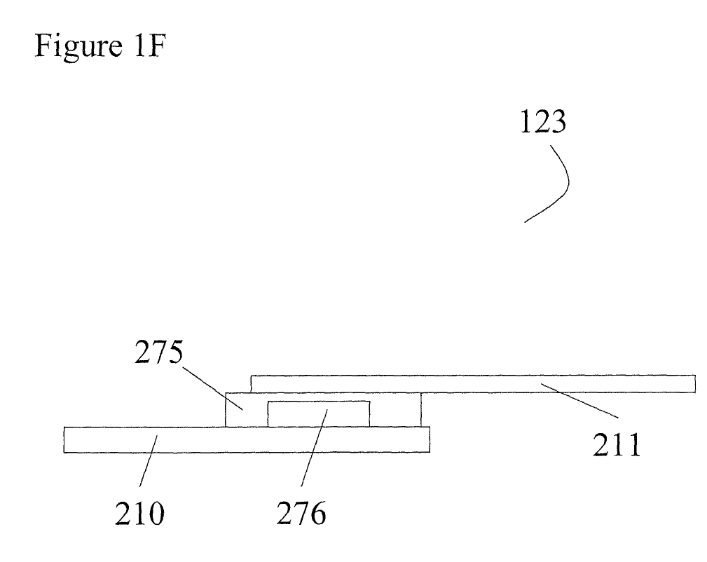

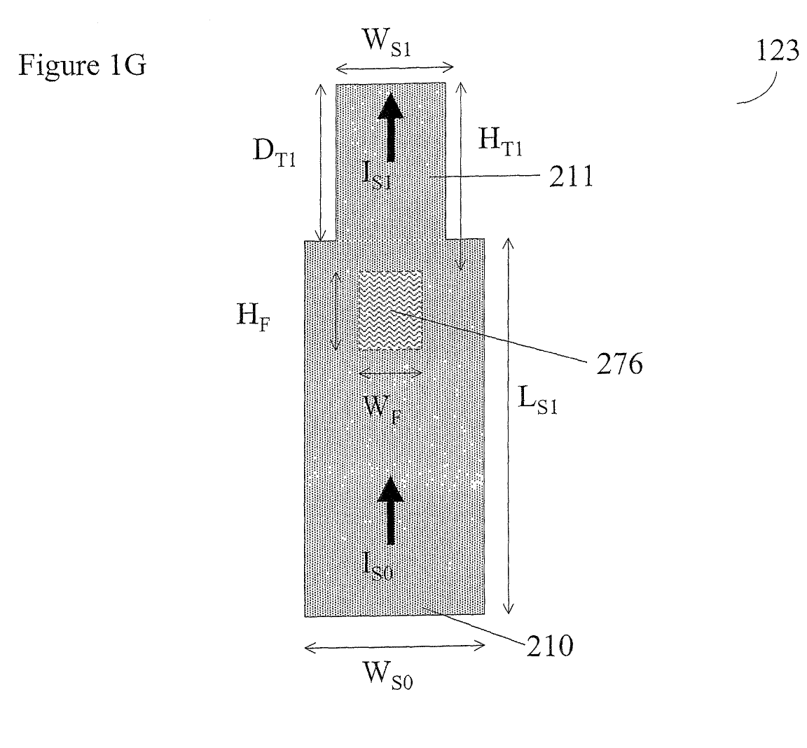

Phase shift devices have been described previously by Geordie Rose, Mohammad H. S. Amin, Timothy Duty, Alexandre Zagoskin, and Alexander Omelyanchouk in U.S. provisional application serial No. 60/257,624: “Intrinsic phase shift device as an element of a qubit.” The phase shift devices will be described in relation to FIGS. 1A through 1G.

FIG. 1A illustrates an example of a phase shift device 123 with the architecture of a first superconducting terminal 210, a second superconducting terminal 211, both superconducting terminals coupled to a phase shifter, in this embodiment, a d-wave superconductor 240. First superconducting terminal 210 has a first order parameter, having a first phase, and second superconducting terminal 211 has a second order parameter, having a second phase. The phase shifter is capable of introducing a difference between the first phase and the second phase. The difference between the first phase and the second phase will be referred to as a phase shift. Currents flowing in superconducting terminals 210 and 211 are labeled I_{S0} and I_{S1}, respectively.

FIG. 1A illustrates a plan view of an embodiment of a two terminal phase shift device 123 having a S/N/D/N/S heterostructure. Here “S” stands for an s-wave superconductor, “N” for a normal metal, and “D” for a d-wave superconductor. The embodiment shown in FIG. 1A includes s-wave superconducting terminal 210, electrically coupled to a normal metal connector 250, which is electrically coupled to a phase shifter.

In this embodiment the phase shifter is a d-wave superconductor 240. In different embodiments the phase shifter can be any anisotropic superconductor, for example a p-wave, a d-wave, or an s+d wave superconductor. In some embodiments d-wave superconductor 240 is a high temperature superconductor, such as YBa₂Cu₃O_{7-d}, where d is between about 0 and about 0.6. In some embodiments superconducting terminals 210 and 211 can be superconductors of any type.

D-wave superconductor 240 is further electrically coupled to a normal metal connector 251, which is electrically coupled to s-wave superconducting terminal 211. In some embodiments the lengths L_{S0}, L_{S1}, L_{S2}, and L_{S3}, and widths W_{S0} and W_{S1} of superconducting terminals 210 and 211 can all be different. In some embodiments, the lengths and widths of superconducting terminals 210 and 211 can all be less than about five microns.

D-wave superconductor 240 is coupled to superconducting terminal 210 on a first side and to superconducting terminal 211 on a second side. The first and second sides define an angle θ, shown in FIG. 1A. The angle θ determines the phase shift caused by the phase shift device 123. For example, in embodiments, where first and second sides are at a right angle with respect to each other, the total phase shift is π across phase shift device 123. In embodiments, where the first and second sides are directly opposite and parallel to each other (θ=0°), the total phase shift is zero across phase shift device 123. Following from this, a generic angle θ leads to a phase shift of 2θ.

FIG. 1B illustrates an embodiment of a π-phase shift device. The angle θ is 90°, causing a phase shift of 180°, or π in radians. In this embodiment normal metal connector 250 is parallel with a crystal axis orientation of d-wave superconductor 240, and normal metal connector 251 is parallel with another crystal axis orientation of d-wave superconductor 240. In some embodiments normal metal connectors 250 and 251 are not parallel to crystal axis orientations, but form an angle θ of 90°.

The physical characteristics, width and length of normal metal connectors 250 and 251 can be chosen so as to form a Josephson junction between superconducting terminal 210 and d-wave superconductor 240, and between superconducting terminal 211 and d-wave superconductor 240. The dimensions of d-wave superconductor 240 and normal metal connectors 250 and 251 are not critical.

In some embodiments superconducting terminals 210 and 211 can be niobium (Nb), aluminum (Al), lead (Pb) or tin (Sn). An embodiment of the invention can have superconducting terminals 210 and 211 made of niobium, connectors 250 and 251 of gold, and d-wave superconductor 240 of YBa₂Cu₃O_{6.68}. Lengths L_{S0}, L_{S1}, L_{S2}, and L_{S3} can be approximately 0.5 microns, widths W_{S0} and W_{S1}, can be approximately 0.5 microns, and connectors 250 and 251 can be approximately 0.05 microns thick. The embodiment of phase shift device 123 shown in FIG. 1B will produce a total phase shift of π accumulated in transition between superconducting terminals 210 and 211.

FIG. 1C illustrates a plan view of a two-terminal embodiment of phase shift device 123. Phase shift device 123 includes a heterostructure containing a Josephson junction 260 between two anisotropic superconductors 241 and 242. In some embodiments anisotropic superconductors 241 and 242 can be d-wave superconductors, such as YBa₂Cu₃O_{7-d}, where 0<d<0.6. Anisotropic superconductors 241 and 242 have crystal axis orientations θ and θ′ with respect to the grain boundary, defining an angle of mismatch θ″, where θ″=θ−θ′. In general, the crystal axis orientation of a superconductor correlates with the orientation of the order parameter of that superconductor. Modifying the angle of mismatch θ″ of anisotropic superconductors 241 and 242 with respect to grain boundary affects the phase shift across grain boundary 260. For example, FIG. 1C illustrates a mismatch angle of θ″=45°, causing a π/2-phase shift. The behavior of such junctions is well known, as described in detail by C. Bruder, A. van Otterlo, and G. T. Zimanyi in “Tunnel Junctions of Unconventional Superconductors,” Phys. Rev. B 51, 12904-07 (1995), and by R. R. Schultz, B. Chesca, B. Goetz, C. W. Schneider, A. Schmehl, H. Bielefeldt, H. Hilgenkamp, J. Marnhart, and C. C. Tsuei in “Design and Realization of an all d-Wave dc π-Superconducting Quantum Interference Device,” Applied Physics Letters, 76, p. 912-14 (2000), both publications incorporated hereby in their entirety by reference.

In some embodiments Josephson junction 260 is formed as a grain boundary junction. Superconductors often form on substrates so that the crystal axis orientation and thus the orientation of the order parameter of the superconductor is determined by the crystal axis orientation of the substrate. Therefore a grain boundary junction can be formed by depositing anisotropic superconductors 240 and 241 onto a bi-crystal substrate with an existing lattice-mismatched grain boundary. The grain boundary of the bi-crystal substrate can force anisotropic superconductors 240 and 241 to form with crystal axis orientations that themselves form a grain boundary, creating a junction.

FIG. 1D illustrates a cross sectional view of phase shift device 123. Anisotropic superconductors 241 and 242 are grown on substrate 90. In some embodiments, substrate 90 can be a bi-crystal substrate with a preexisting grain boundary. Substrate 90 can be formed from insulators, such as SrTiO₃ (strontium titanate) or Ti:Al₂O₃ (sapphire), which are commercially available.

In this embodiment anisotropic superconductors 240 and 241 are coupled to superconducting terminals 210 and 211 by c-axis heterostructure junctions. The c-axis heterojunctions can be created by forming normal metal connectors 250 and 251 on anisotropic superconductors 241 and 242, respectively. Superconducting terminals 211 and 210 can subsequently be deposited over normal metal connectors 250 and 251. Finally, an insulating layer 50 can be formed overlying anisotropic superconductors 241 and 242, but having openings for superconducting terminals 210 and 211.

Normal metal connectors 250 and 251 can be formed from metallic conductors, such as gold, silver, or aluminum, or semiconductors, such as doped gallium-arsenide. Anisotropic superconductors 241 and 242 can be d-wave superconductors, such as YBa₂Cu₃O_{7-d}, where d is between about 0 and about 0.6. Insulating material 50 can be any material capable of electrically isolating superconducting terminals 210 and 211.

Josephson junction 260 between anisotropic superconductors 241 and 242 can be a grain boundary. In some embodiments, junction 260 can be formed by using a bi-epitaxial method, where an anisotropic superconducting material is deposited onto substrate 90 that is partially covered by a seed layer. When the anisotropic superconductor is deposited on the substrate and the seed layer, it will grow with crystal axes determined by the crystal axes of the underlying angles. The crystal axis of the seed layer can be oriented with an orientation different from the orientation of the crystal axis of the substrate. In this case the anisotropic superconductor will grow with different crystal axis orientation on the seed layer and on the substrate itself. Therefore at the edge of the seed layer a grain boundary will be created within the anisotropic superconductor, forming in effect anisotropic superconductors 240 and 241. In some embodiments the substrate can be an insulator, for example, strontium titanate, and the seed layer can be CeO (cerium oxide) or MgO (magnesium oxide). Aspects of the fabrication of superconducting devices have been described, for example, by F. Tafuri, F. Carillo, F. Lombardi, F. Miletto Granozio, F. Ricci, U. Scotti di Uccio, A. Barone, G. Testa, E. Samelli, J. R. Kirtley in “Feasibility of Biepitaxial YBa₂Cu₃O₇₋ₓ Josephson Junctions for Fundamental Studies and Potential Circuit Implementation,” Los Alamos preprint cond-mat/0010128 (2000), incorporated hereby in its entirety by reference.

In some embodiments normal metal connector 250 couples anisotropic superconductor 241 to s-wave superconducting terminal 211. In some embodiments normal metal connector 251 couples anisotropic superconductor 242 to s-wave superconducting terminal 210. In some embodiments normal metal connectors 250 and 251 can be gold (Au), silver (Ag), platinum (Pt), or any other metal, and s-wave superconducting terminals 210 and 211 can be aluminum (Al), niobium (Nb), or any other conventional superconductor.

In some embodiments lengths L_{S0}, L_{S1}, LS₂, and LS₃, and widths W_{S0} and W_{S1} can all be different. In some embodiments each of the lengths can be less than about one micron. The physical characteristics and spatial extent of normal metal connectors 250 and 251 can be chosen so as to form Josephson junctions between superconducting terminals 210 and anisotropic superconductor 241, and between superconducting terminals 211 and anisotropic superconductor 242, respectively. Currents flowing in superconducting terminals 210 and 211 are labeled I_{S0} and Is, respectively. The dimensions of anisotropic superconductors 241 and 242, and normal metal connectors 250 and 251 are not critical.

In accordance with an embodiment of phase shift device 123, as shown in FIG. IC, superconducting terminals 210 and 211 can be made of niobium, connectors 250 and 251 of gold, and anisotropic superconductors 241 and 242 can be made of YBa₂CU₃O_{6 68}. Lengths L_{S0}, L_{S1}, L_{S2}, and L_{S3} can be approximately 0.5 microns, widths W_{S0} and W_{S1}, can be approximately 0.5 microns, and normal metal connectors 250 and 251 can be approximately 0.05 microns thick. Anisotropic superconductors 241 and 242 can have a symmetric 22.5°/22.5° lattice mismatch, in which the crystal axis orientation of anisotropic superconductor 241 makes an angle of +22.5° with grain boundary junction 260 and the crystal axis orientation of anisotropic superconductor 242 makes an angle of −22.5° with grain boundary junction 260. This type of grain boundary junction 260 is typically called a symmetric 45° grain boundary, as the angle between the crystallographic axis orientations of superconductors 241 and 242 is 45°. This embodiment produces a phase shift of π accumulated across grain boundary junction 260. This embodiment is also “quiet” in the sense that no spontaneous supercurrents or magnetic fluxes are produced at a symmetric 45° grain boundary and therefore noise due to phase shift device 123 in a superconducting electronic circuit is reduced.

FIG. 1E illustrates a plan view of another embodiment of a two terminal phase shift device 123. This embodiment includes a junction area between superconducting terminal 210 and superconducting terminal 211, and a ferromagnet 276 formed in the junction area. In this embodiment ferromagnet 276 is overlying superconducting terminal 210, and superconducting terminal 211 overlies ferromagnet 276. An insulating region 275 is formed to isolate superconducting terminals 210 and 211 from each other. The Josephson junction between superconducting terminal 210 and superconducting terminal 211 is along the axis normal to the plane shown in FIG. 1E.

The geometry of ferromagnet 276 determines the angle of the phase shift. In FIG. 1E, lengths L_{S0}, and L_{S3} indicate the lengths of superconducting terminals 210 and 211, respectively. HTO and HTI indicate the distance between the edge of superconducting terminals 210 and 211, respectively, and the edge of insulating region 275. The quantities HF and WF indicate the height and width of ferromagnet 276, respectively. The length D_{T1} indicates the distance between the edge of superconducting terminal 211 and the edge of superconducting terminal 210. In some embodiments lengths and widths D_{T1}, H_{T1}, L_{S2}, H_{T0}, W_{S0}, and W_{S1} can be all different and, in some embodiments, are all less than about five microns. In some embodiments lengths H_{F} and W_{F} can be different and, in some embodiments, can be less than about one micron, with these lengths chosen so as to give the desired phase shift. Currents flowing in superconducting terminals 210 and 211 are labeled I_{S0} and I_{S1}, respectively.

FIG. 1F illustrates a cross sectional view of an embodiment of phase shift device 123 with ferromagnet 276 between s-wave superconducting terminal 210 and s-wave superconducting terminal 211. Insulating region 275 provides insulation between superconducting terminals 210 and 211.

In some embodiments superconducting terminals 210 and 211 can be niobium (Nb), aluminum (Al), lead (Pb), tin (Sn), or any other superconductor with s-wave pairing symmetry. In some embodiments insulating region 275 can be aluminum oxide (AlO₂), or any other insulating material. In some embodiments ferromagnet 276 can be an alloy of copper and nickel (Cu:Ni), or any other ferromagnetic material. One method of fabricating the embodiment of phase shift device 123 as shown in FIGS. 1E and 1F, is described by V. V. Ryazanov, V. A. Oboznov, A. Yu. Rusanov, A. V. Veretennikov, A. A. Golubov, J. Aarts in “Coupling of Two Superconductors Through a Ferromagnet: Evidence for a π-Junction,” LANL preprint condmat/0008364 (August 2000), incorporated hereby in its entirety by reference.

FIG. 1G illustrates a plan view of another embodiment of a two terminal phase shift device 123 having ferromagnet 276 embedded in the junction area between s-wave superconducting terminals 210 and 211. In this embodiment the s-wave superconducting terminal/ferromagnet/s-wave superconducting terminal 210/276/211 junction is in the plane of FIG. 1G. Thus, ferromagnet 276 is directly in the plane of superconducting terminals 210 and 211. The geometry of ferromagnet 276 determines the phase shift of the junction. In some embodiments lengths and widths D_{T1}, H_{T1}, L_{S2}, W_{S0}, and W_{S1} can be all different and, in some embodiments, all are less than about five microns. In some embodiments lengths H_{F} and W_{F} can be different and less than about one micron, with these lengths chosen to give the desired phase shift. Currents flowing in superconducting terminals 210 and 211 are labeled I_{S0} and I_{S1}, respectively. In some embodiments superconducting terminals 210 and 211 can be niobium (Nb), aluminum (Al), lead (Pb) tin (Sn), or any other superconductor with s-wave pairing symmetry. In some embodiments ferromagnet 276 can be an alloy of copper and nickel (Cu:Ni) or any other ferromagnetic material. Ferromagnet 276 can be prepared by, for example, implantation of a ferromagnetic substance into a superconducting junction.

Phase shift device 123, as an element of a superconducting circuit, has previously been described, for example, by G. Rose, M. Amin, T. Duty, A. Zagoskin, and A. Omelyanchouk in U.S. Provisional Application Serial No. 60/257,624. For example, phase shift device 123 can be included into a qubit, or in a superconducting loop, inducing a phase shift α, where α can range between 0 and π.

Many superconducting qubit designs require a phase shift to make the two basis states of the qubit degenerate. In some designs, degeneracy between the basis states is achieved by the application of a static magnetic field. Such magnetic fields can cause dissipation in the time evolution of the basis states of the qubit and are thus undesirable.

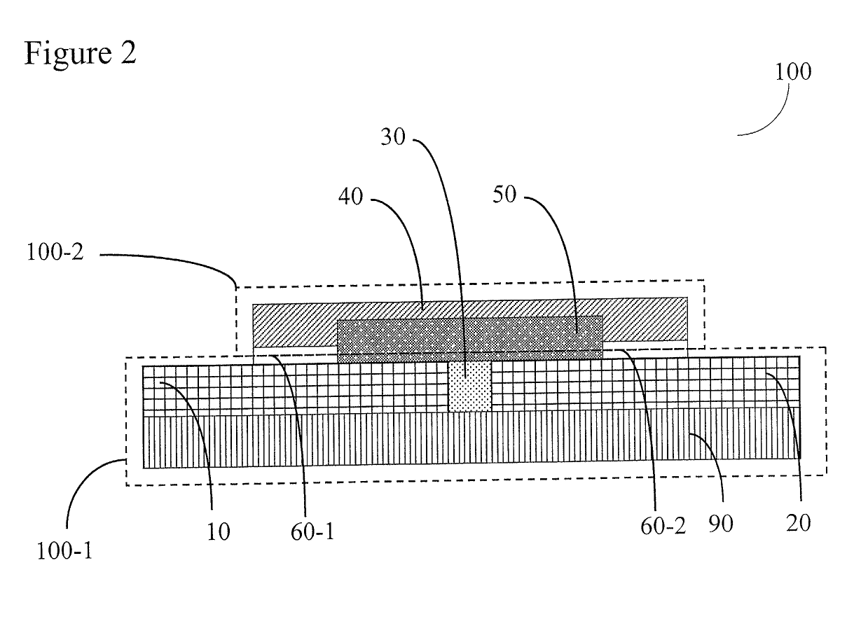

FIG. 2 illustrates an embodiment of the invention, where phase shift device 123 is incorporated into a qubit design. Phase shift device 123 is capable of making the two basis states of the qubit degenerate without the application of magnetic fields. The particular design, known as a supercounducting low inductance qubit (SLIQ), has been previously disclosed by A. Zagoskin, A. Tsalentchouk, and J. Hilton in U. S. Provisional Application Serial No. 60/316,134, entitled “Superconducting low inductance qubit,” filed Aug. 29, 2001, the provisional application and the references therein incorporated herein by this reference in their entirety. A SLIQ includes a superconducting loop with a first portion and a second portion. The first portion of the loop includes a Josephson junction, separating two anisotropic superconducting materials. The second portion of the loop includes a conventional superconducting material that is coupled to the first portion of the loop such that it spans across the Josephson junction formed by the two anisotropic superconducting materials of the first loop. In some embodiments, the conventional superconducting material of the second portion of the loop can be coupled to the material of the first portion of the loop through c-axis heterostructure tunnel junctions.

FIG. 2 illustrates an embodiment 100, where the SLIQ includes a loop that includes a first loop portion 100-1 and a second loop portion 100-2. First loop portion 100-1 interfaces with second loop portion 100-2 through junctions 60-1 and 60-2. First loop portion 100-1 includes phase shift device 123, including a first superconducting material 10, a second superconducting material 20, separated by a phase shift mechanism 30, capable of introducing a desired phase shift. Second loop portion 100-2 includes superconducting material 40. In some other embodiments the phase shift can be introduced by, for example, a grain boundary. The desired amount of phase shift in some embodiments is α=π/2, as such a phase shift makes the two basis states degenerate, so that the SLIQ can function as a qubit device. This embodiment also includes substrate 90 and insulating material 50.

Methods of fabricating first loop portion 100-1 and second loop portion 100-2 may require different technologies. An example of a method of fabricating such a device, as described in the referenced U.S. Provisional Application Serial No. 60/316,134, includes preparing and insulating first loop portion 100-1, etching regions of an insulating material to prepare c-axis heterostructure junctions, depositing an intermediate material, and despositing a material forming second loop portion 100-2. First loop portion 100-1 can include any phase shifter device 123 in accordance with the present invention, that can introduce a π/2 phase shift in transition over first loop portion 100-1.

According to this method of fabricating qubits with SLIQ designs, the techology for fabricating phase shift device 123 can be different from the technology for fabricating the remainder of the device. This advantageous aspect makes these embodiments of the invention convenient for scaling, and forming larger arrays and circuitry.

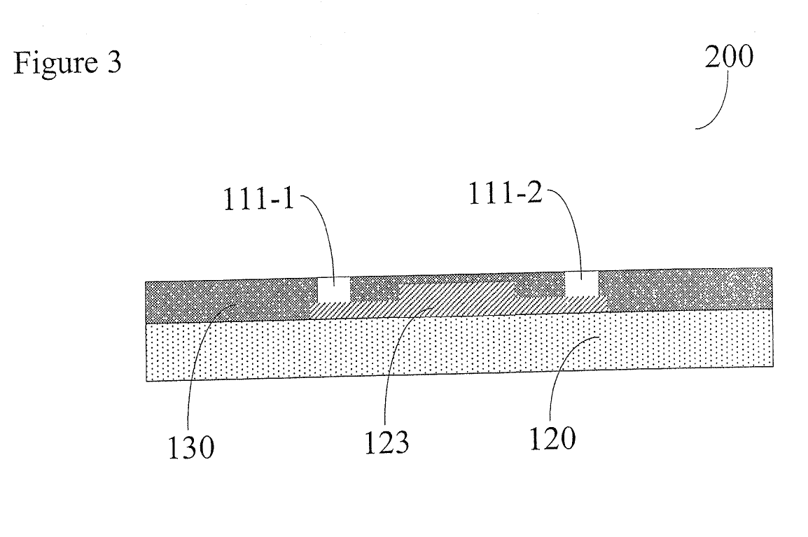

An embodiment of the present invention provides method for fabricating a phase shifter device, as part of a device that can require different fabrication methods. FIG. 3 illustrates acts of fabricating an embodiment of phase shift circuitry 200. In a first act phase shift device 123 can be fabricated on a substrate 120. An insulating layer 130 can be deposited over phase shift device 123 to isolate it from the conventional superconducting circuitry. Materials that can be used to form substrate 120 include sapphire and SrTiO₃. Contact terminals 111-1 and 111-2 can be formed by first etching openings into insulating layer 130 to provide an electrical coupling to phase shift device 123. The openings can be etched, for example, by electron beam lithography. Subsequently, conducting materials can be deposited into the openings to form contact terminals 111-1 and 111-2.

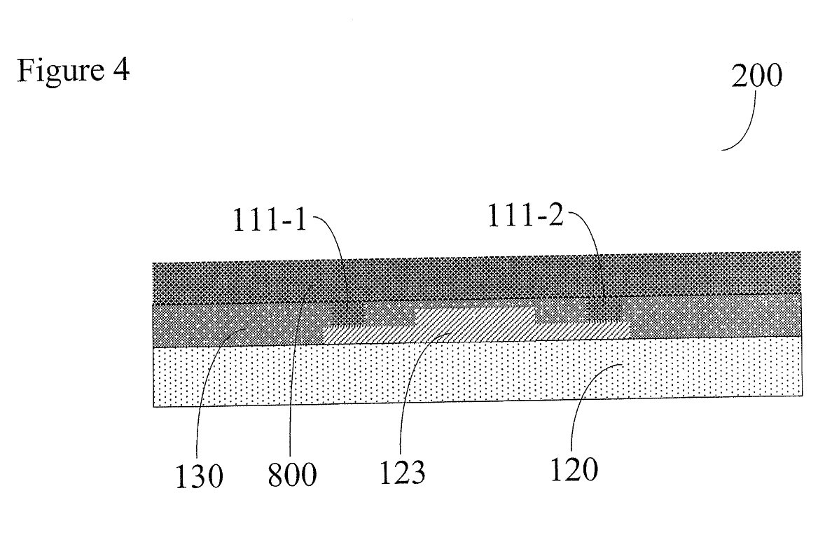

FIG. 4 illustrates subsequent acts of fabricating phase shift circuitry 200, wherein a conventional superconducting circuitry layer 800 has been deposited on insulating layer 130, connecting to phase shift device 123 through contact terminals 111-1 and 111-2 respectively. Conventional superconducting circuitry layer 800 can be formed from any conventional superconductor, including s-wave superconductors, such as aluminum.

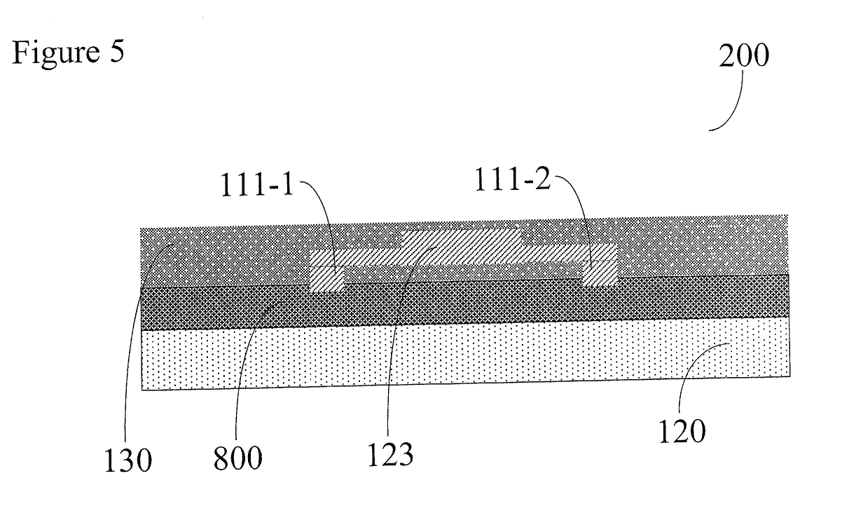

FIG. 5 illustrates an alternative method of forming phase shift circuitry 200. An act of this method is to form conventional superconducting circuitry layer 800 on substrate 120. Substrate 120 can be formed, for example, from sapphire and SrTiO₃. A first portion of insulating layer 130 can be deposited over conventional superconducting circuitry layer 800. Contact terminals 111-1 and 111-2 can be formed in the first portion of insulating layer 130 to provide electrical coupling between conventional superconducting circuitry layer 800 and phase shift device 123. Phase shift device 123 can be fabricated overlying the first portion of insulating layer 130. Phase shift device 123 can be coupled electrically to superconducting circuitry layer 800 through contact terminals 111-1 and 111-2. Next, a second portion of insulating layer 130 can be deposited to isolate phase shift circuitry 300 from its environment.

Some embodiments of the invention can be fabricated using the same fabrication methods as those used to fabricate the superconducting qubit.

One of the most important advantages of superconducting qubit proposals is the scalability to large numbers of qubits. Useful numbers of qubits can be on the order of 10² to 10³ qubits. Such large numbers of qubits are necessary to perform complex quantum algorithms using quantum computers. Thus, an embodiment of the invention provides a method for fabricating a chip that includes a plurality of phase shifter devices, as an initial step in fabricating a plurality of qubit devices. In some embodiments of the invention several phase shift devices 123 are arranged in an array to form a phase shifter chip 500.

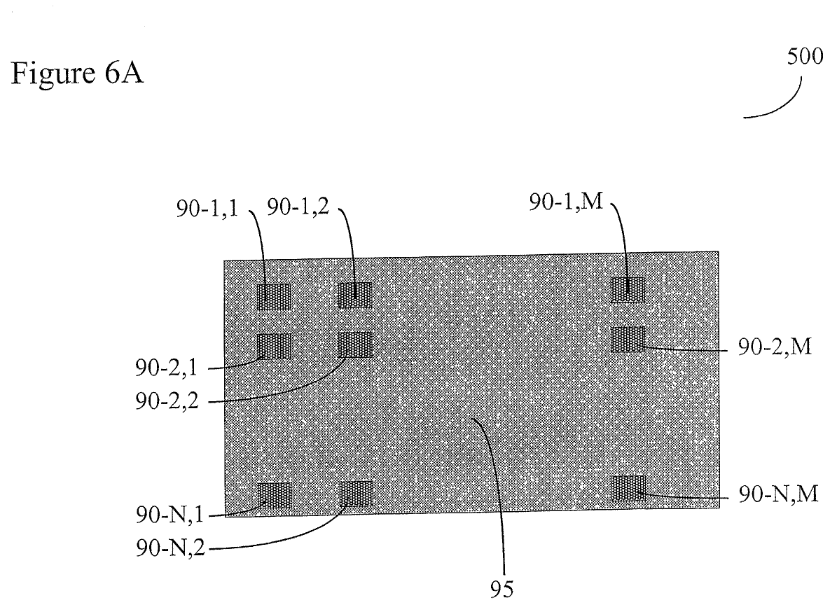

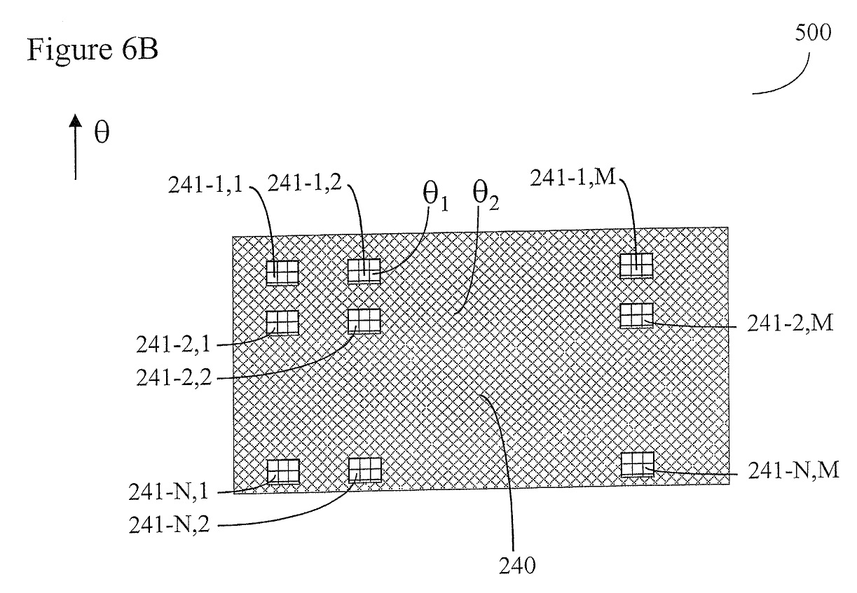

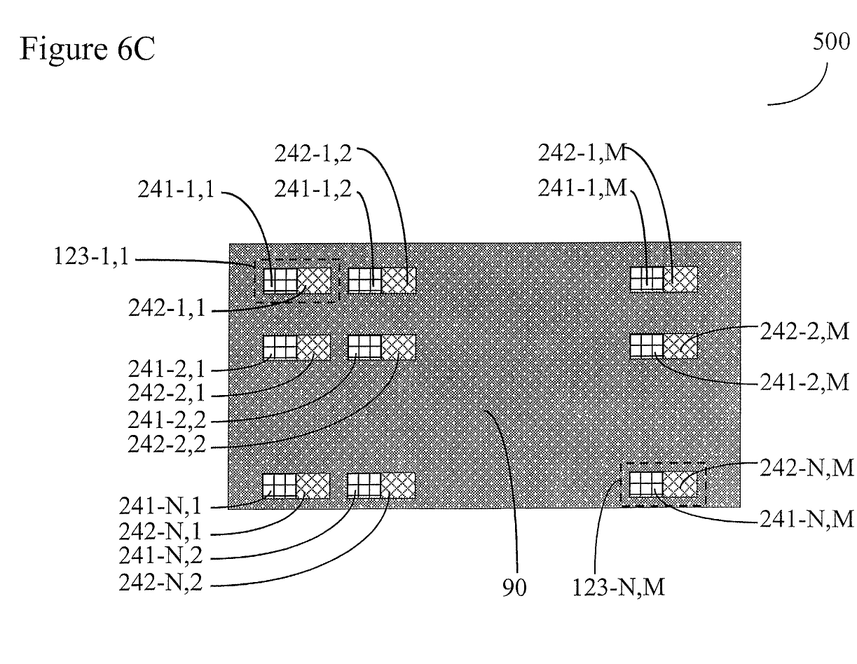

FIGS. 6A-C illustrate a method of forming a phase shifter chip 500 that includes N×M phase shift devices 123.

FIG. 6A illustrates the method of forming a phase shifter chip 500 with bi-epitaxial fabrication. A substrate 90 is formed and a seed layer 95 is formed overlying substrate 90. Openings 90-1,1 through 90-N,M are etched into seed layer 95 to expose underlying substrate 90. Substrate 90 can be formed from strontium titanate or sapphire. Seed layer 95 can be formed from, for example, MgO or CeO.

FIG. 6B illustrates that in a next act superconductor 240 is formed overlying seed layer 95. In the openings of seed layer 95 the orientation of the crystal axes of superconductor 240 will be determined by θ₂, the orientation of the crystal axis of substrate 90 to form anisotropic superconducting regions 241-1,1 through 241-N,M. In the regions away from the openings of seed layer 95 the orientation of the crystal axes of superconductor 240 will be determined by 02, the orientation of the crystal axis of seed layer 95. The orientation of the superconducting order parameter of superconductor 240 is typically parallel or perpendicular to the orientation of the crystal axis of superconducting material 240. In some cases the orientation of the order parameter of superconductor 240 can form an angle different from 0° or 90° with the crystal axes of the underlying material. Since the orientation of the crystal axes of superconductor 240 is different in the region of the openings and away from the openings, the orientation of the order parameter of superconductor 240 will be different in the openings and away from the openings. Therefore Josephson-junctions will be formed at the boundary regions between anisotropic superconducting regions 241-1,1 through 241-N,M and superconductor 240.

FIG. 6C illustrates a next act of forming phase shifter chip 500. Superconductor 240 is etched away except in an array of regions, forming anisotropic superconducting regions 242-1,1 through 242-N,M. In this architecture anisotropic superconducting regions 242-1,1 through 242-N,M form Josephson-junctions with anisotropic superconducting regions 241-1,1 through 241-N,M.

A method of forming anisotropic superconducting regions 242-1,1 through 242-N,M includes depositing a mask layer over superconductor 240, then exposing and hardening the mask layer everywhere, with the exception of the regions where anisotropic superconducting regions 242-1,1 through 242-N,M are to be formed. The hardened mask layer regions will safeguard the anisotropic superconducting regions 242-1,1 through 242-N,M in the subsequent etching step. In a next act the mask layer is etched away everywhere except in the hardened regions. Superconductor 240 and seed layer 95 are also etched away where exposed after the removal of the mask layer. The presented etching method creates anisotropic superconducting regions 242-1,1 through 242-N,M. The Josephson-junction-coupled anisotropic superconducting regions 241-1,1 through 241-N,M and anisotropic superconducting regions 242-1,1 through 242-N,M form an array of phase shift devices 123-1,1 through 123-N,M.

In a next act an insulating layer is deposited over the array of phase shift devices 123-1,1 through 123-N,M, and a corresponding array of contact terminals are formed. Next a conventional superconductor circuitry layer is formed over the insulating layer. Conventional superconductor logic can be formed in the conventional superconductor circuitry layer, which will be coupled to the array of phase shift devices 123-1,1 through 123-N,M through the array of contact terminals. Heterostructure junctions are described in U.S. Patent Application No. 10/006,787, by A. Tzalenchuk, Z. Ivanov, and M. Steininger, entitled “Trilayer Heterostructure Junctions”, filed Dec. 6, 2001, and the references therein, which is herein incorporated in its entirety by reference.

Although the various aspects of the present invention have been described with respect to certain embodiments, it is understood that the invention is entitled to protection within the full scope of the appended claims.

We claim:

1. A phase shift device, comprising:
a first superconducting terminal, having a first phase;
a second superconducting terminal, having a second phase; and
a phase shifter, coupled to the first superconducting terminal and to the second superconducting terminal, wherein
the phase shifter is capable of causing a predefined difference between the first phase and the second phase.

2. The phase shift device of claim 1, wherein
the phase shifter comprises an anisotropic superconductor.

3. The phase shift device of claim 2, wherein
the anisotropic superconductor is a d-wave superconductor.

4. The phase shift device of claim 2, wherein
the first superconducting terminal and the second superconducting terminal comprise s-wave superconductors.

5. The phase shift device of claim 2, wherein
the anisotropic superconductor is coupled to the first superconducting terminal through a first side; and
the anisotropic superconductor is coupled to the second superconducting terminal through a second side; wherein
the first side and the second side define a mismatch angle.

6. The phase shift device of claim 5, wherein
the mismatch angle is about 90 degrees.

7. The phase shift device of claim 2, wherein
the phase shifter is electrically coupled to the first superconducting terminal through a first connector; and
the phase shifter is electrically coupled to the second superconducting terminal through a second connector.

8. The phase shift device of claim 7, wherein
the first superconducting terminal, the second superconducting terminal, the first connector, the second connector, and the phase shifter overlie a substrate.

9. The phase shift device of claim 8, wherein
the first connector is adjacent to the phase shifter;
the first superconducting terminal is adjacent to the first connector;
the second connector is adjacent to the phase shifter; and
the second superconducting terminal is adjacent to the second connector.

10. The phase shift device of claim 7, wherein
the first connector and the second connector comprise normal metals.

11. The phase shift device of claim 2, wherein
the length and the width of the first superconducting terminal and the length and the width of the second superconducting terminal are less than about 5 microns, wherein
the first superconducting terminal and the second superconducting terminal have length and width.

12. The phase shift device of claim 2, wherein
the coupling of the phase shifter and the first superconducting terminal comprises a first Josephson junction; and
the coupling of the phase shifter and the second superconducting terminal comprises a second Josephson junction.

13. The phase shift device of claim 2, wherein
the first superconducting terminal and the second superconducting terminal comprise niobium, aluminum, lead, or tin;
the phase shifter comprises YBa₂Cu₃O_{7-d}, wherein d has a value between about 0 and about 0.6; and
the first connector and the second connector comprise gold, silver, or platinum.

14. The phase shift device of claim 2, wherein the phase shifter comprises:
a plurality of anisotropic superconductors.

15. The phase shift device of claim 14, wherein the phase shifter comprises:
a first anisotropic superconductor; and
a second anisotropic superconductor, wherein
the first superconductor and the second superconductor are coupled by a Josephson-junction.

16. The phase shift device of claim 15, wherein the Josephson-junction comprises:
a grain boundary.

17. The phase shift device of claim 15, wherein
the first anisotropic superconductor has a first order parameter with a first orientation, and
the second anisotropic superconductor has a second order parameter with a second orientation, wherein
the first orientation and the second orientation define a mismatch angle.

18. The phase shifter device of claim 17, wherein
the mismatch angle is about 45 degrees.

19. The phase shift device of claim 15, wherein
the first anisotropic superconductor and the second anisotropic superconductor overlie a substrate.

20. The phase shift device of claim 19, wherein
the first connector overlies the first anisotropic superconductor; and
the second connector overlies the second anisotropic superconductor.

21. The phase shift device of claim 20, wherein
the first superconducting terminal overlies the first connector; and
the second superconducting terminal overlies the second connector.

22. The phase shift device of claim 1, wherein the phase shifter comprises:
a ferromagnet.

23. The phase shift device of claim 22, wherein
the ferromagnet is an alloy of copper and nickel.

24. The phase shift device of claim 22, wherein
the first superconducting terminal overlies a substrate;
the ferromagnet overlies the first superconducting terminal; and
the second superconducting terminal overlies the ferromagnet.

25. The phase shift device of claim 24, wherein
the second superconducting terminal is isolated from the first superconducting terminal by an insulator.

26. The phase shift device of claim 25, wherein
the insulator is polymethylmethacrylate or AlOₓ, wherein x is an integer.

27. The phase shift device of claim 24, wherein
the length and width of the first superconducting terminal, the ferromagnet and the second superconducting terminal, and
the relative position of the first superconducting terminal, the ferromagnet and the second superconducting terminal is such that they cause a predefined difference between the first phase and the second phase, wherein
the first superconducting terminal, the ferromagnet and the second superconducting terminal have a length, a width, and a relative position.

28. The phase shift device of claim 22, wherein
the first superconductor terminal and the second superconductor terminal are coupled by a junction area; and
the ferromagnet is embedded in the junction area.

29. The phase shift device of claim 28, wherein
the length and width of the first superconducting terminal, the ferromagnet and the second superconducting terminal, and
the relative position of the first superconducting terminal, the ferromagnet and the second superconducting terminal is such that they cause a predefined difference between the first phase and the second phase, wherein
the first superconducting terminal, the ferromagnet and the second superconducting terminal have a length, a width, and a relative position.

30. The phase shift device of claim 1, further comprising:
a conventional superconducting terminal, coupled to the first superconducting terminal by a first junction, and coupled to the second superconducting terminal by a second junction,
the first superconducting terminal, the second superconducting terminal, and the conventional superconducting terminal forming a loop.

31. The phase shift device of claim 30, wherein
the first and second junctions are c-axis heterojunctions.

32. The phase shift device of claim 30, wherein
the predefined difference between the first phase and the second phase is about π/2.

33. A phase shift device, comprising:
a first superconducting terminal means, having a first phase;
a second superconducting terminal means, having a second phase; and
a phase shifter means, coupled to the first and second superconducting terminal means, capable of causing a predefined difference between the first phase and the second phase.

34. The phase shift device of claim 33, wherein
the phase shifter means comprise a d-wave superconductor.

35. A phase shifting method, the method comprising:
providing a first superconducting terminal, having a first phase;
providing a second superconducting terminal, having a second phase; and
coupling a phase shifter to the first superconducting terminal and to the second superconducting terminal, wherein
the phase shifter is capable of causing a predefined difference between the first phase and the second phase.

36. The method of claim 35, wherein providing a phase shifter comprises:
providing an anisotropic superconductor.

37. The method of claim 35, wherein coupling the phase shifter comprises:
coupling the first superconducting terminal to a first side of the phase shifter;
coupling the second superconducting terminal to a second side of the phase shifter, wherein
the first side and the second side of the phase shifter define a mismatch angle.

38. The method of claim 37, wherein
coupling the first superconducting terminal to the first side of the phase shifter comprises:
coupling the first superconducting terminal to a first connector, and
coupling the first connector to the phase shifter; and
coupling the second superconducting terminal to the second side of the phase shifter comprises:
coupling the second superconducting terminal to a second connector, and
coupling the second connector to the phase shifter.

39. The method of claim 35, wherein providing the phase shifter comprises:
providing a first anisotropic superconductor, having a first order parameter with a first orientation, and
providing a second anisotropic superconductor, having a second order parameter with a second orientation, wherein
the first orientation and the second orientation define a mismatch angle.

40. The method of claim 35, wherein providing the phase shifter comprises:
coupling the first superconducting terminal and the second superconduting terminal with a junction; and
providing a ferromagnet in the junction.

41. A phase shifter circuitry, comprising:
a phase shift device, comprising:
a first superconducting terminal, having a first phase;
a second superconducting terminal, having a second phase; and
a phase shifter, coupled to the first superconducting terminal and to the second superconducting terminal, wherein
the phase shifter is capable of causing a predefined difference between the first phase and the second phase; and
superconducting circuitry, coupled to the phase shift device.

42. The phase shifter circuitry of claim 41, wherein
the phase shifter comprises an anisotropic superconductor.

43. The phase shifter circuitry of claim 41, wherein
the anisotropic superconductor is coupled to the first superconducting terminal through a first side; and
the anisotropic superconductor is coupled to the second superconducting terminal through a second side; wherein
the first side and the second side define a mismatch angle.

44. The phase shifter circuitry of claim 41, wherein
the phase shifter is electrically coupled to the first superconducting terminal through a first connector; and
the phase shifter is electrically coupled to the second superconducting terminal through a second connector.

45. The phase shifter circuitry of claim 41, wherein
the first superconducting terminal and the second superconducting terminal comprise niobium, aluminum, lead, or tin;
the phase shifter comprises YBa₂Cu₃O_{7-d}, wherein d has a value between about 0 and about 0.6; and
the first connector and the second connector comprise gold, silver, or platinum.

46. The phase shifter circuitry of claim 41, wherein the phase shifter comprises:
a first anisotropic superconductor, having a first order parameter with a first orientation; and
a second anisotropic superconductor, having a second order parameter with a second orientation, wherein
the first orientation and the second orientation define a mismatch angle; and
the first superconductor and the second superconductor are coupled by a Josephson-junction.

47. The phase shifter circuitry of claim 41, wherein
the first anisotropic superconductor and the second anisotropic superconductor overlie a substrate;
the first connector overlies the first anisotropic superconductor;
the second connector overlies the second anisotropic superconductor;
the first superconducting terminal overlies the first connector; and
the second superconducting terminal overlies the second connector.

48. The phase shifter circuitry of claim 41, wherein
the first superconducting terminal overlies a substrate;
a ferromagnet overlies the first superconducting terminal; and
the second superconducting terminal overlies the ferromagnet.

49. The phase shifter circuitry of claim 48, wherein
the first superconductor terminal and the second superconductor terminal are coupled by a junction area; and
the ferromagnet is embedded in the junction area.

50. The phase shifter circuitry of claim 41, wherein
the phase shift device overlies a substrate;
the superconducting circuitry overlies the phase shift device; and
a first contact terminal and a second contact terminal couples the superconducting circuitry and the phase shift device.

51. The phase shifter circuitry of claim 50, wherein
the substrate is sapphire or SrTiO₃.

52. The phase shifter circuitry of claim 50, wherein
an insulating layer separates the phase shift device and the superconducting circuitry, wherein
the first contact terminal and the second contact terminal couples the superconducting circuitry and the phase shift device through a first opening and a second opening in the insulating layer, respectively.

53. The phase shifter circuitry of claim 41, wherein
the superconducting circuitry overlies a substrate;
the phase shift device overlies the superconducting circuitry; and
a first contact terminal and a second contact terminal couples the superconducting circuitry and the phase shift device.

54. The phase shifter circuitry of claim 53, wherein
an insulating layer separates the phase shift device and the superconducting circuitry, wherein
the first contact terminal and the second contact terminal couples the superconducting circuitry and the phase shift device through a first opening and a second opening in the insulating layer, respectively.

55. The phase shift circuitry of claim 41, wherein the superconducting circuitry comprises:
quantum computing circuitry.

56. A phase shifter circuitry, comprising:
a phase shift device means, comprising:
a first superconducting terminal means, having a first phase;
a second superconducting terminal means, having a second phase; and
a phase shifter means, coupled to the first and second superconducting terminal means, capable of causing a predefined difference between the first phase and the second phase; and
a superconducting circuitry means, coupled to the phase shifting means.

57. A phase shifting method, the method comprising:
providing a phase shift device, comprising:
providing a first superconducting terminal, having a first phase;
providing a second superconducting terminal, having a second phase; and
coupling the first superconducting terminal and the second superconducting terminal to a phase shifter, wherein
the phase shifter is capable of causing a predefined difference between the first phase and the second phase; and coupling a superconducting circuitry to the phase shift device.

58. The method of claim 57, wherein providing a phase shifter comprises:
providing an anisotropic superconductor.

59. A phase shifter chip, comprising:
a plurality of phase shift devices, the phase shift devices individually comprising:
a first superconducting terminal, having a first phase;
a second superconducting terminal, having a second phase; and
a phase shifter, coupled to the first superconducting terminal and to the second superconducting terminal, wherein
the phase shifter is capable of causing a predefined difference between the first phase and the second phase; and
superconducting circuitry, coupled to the plurality of phase shift devices.

60. The phase shifter chip of claim 59, wherein the phase shifters individually comprise:
an anisotropic superconductor.

61. The phase shifter chip of claim 59, wherein
the first superconducting terminals and the second superconducting terminals comprise niobium, aluminum, lead, or tin; and
the phase shifters individually comprise YBa₂Cu₃O_{7-d}, wherein d has a value between about 0 and about 0.6.

62. The phase shifter chip of claim 59, wherein the phase shifters individually comprise:
a first anisotropic superconductor, having a first order parameter with a first orientation; and
a second anisotropic superconductor, having a second order parameter with a second orientation, wherein
the first orientation and the second orientation define a mismatch angle.

63. The phase shifter chip of claim 62, wherein
the mismatch angle is about 45 degrees.

64. The phase shifter chip of claim 59, wherein in the individual phase shifters
the first anisotropic superconductors and the second anisotropic superconductors are coupled by a Josephson-junction.

65. The phase shifter chip of claim 64, wherein
the Josephson junctions comprise a grain boundary.

66. The phase shifter chip of claim 59, wherein in the individual phase shift devices
the first anisotropic superconductor and the second anisotropic superconductor overlie a substrate;
the first superconducting terminal overlies the first anisotropic superconductor; and
the second superconducting terminal overlies the second anisotropic superconductor.

67. The phase shifter chip of claim 59, wherein
the plurality of phase shift devices overlie a substrate;
the superconducting circuitry overlies the plurality of phase shift devices; and
the individual phase shift devices are coupled to the superconducting circuitry by first contact terminals and second contact terminal.

68. The phase shifter chip of claim 67, wherein
an insulating layer separates the plurality of phase shift devices and the superconducting circuitry, wherein in the individual phase shift devices
the first contact terminal and the second contact terminal couples the superconducting circuitry and the individual phase shift device through a first opening and a second opening in the insulating layer, respectively.

69. The phase shifter chip of claim 59, wherein
the superconducting circuitry overlies a substrate;
the plurality of phase shift devices overlie the superconducting circuitry; and
the individual phase shift devices are coupled to the superconducting circuitry by first contact terminals and second contact terminals.

70. The phase shifter chip of claim 69, wherein
an insulating layer separates the plurality of phase shift devices and the superconducting circuitry, wherein in the individual phase shift devices
the first contact terminal and the second contact terminal couples the superconducting circuitry and the individual phase shift device through a first opening and a second opening in the insulating layer, respectively.

71. The phase shifter chip of claim 59, wherein the superconducting circuitry comprises:
quantum computing circuitry.

72. A phase shifter chip, comprising:
a plurality of phase shift device means, the individual phase shift devices comprising:
a first superconducting terminal means, having a first phase;
a second superconducting terminal means, having a second phase; and
a phase shifter means, coupled to the first and second superconducting terminal means, capable of causing a predefined difference between the first phase and the second phase; and
a superconducting circuitry means, coupled to the plurality of phase shifting means.

73. A method of making a phase shifter chip, the method comprising:
forming a substrate with a first crystal axis orientation;
forming a seed layer with a second crystal axis orientation, overlying the substrate, wherein the second crystal axis orientation is different from the first crystal axis orientation,
forming a plurality of openings in the seed layer; and
forming a plurality of phase shift devices overlying the plurality of openings.

74. The method of claim 73, wherein the forming of a plurality of phase shift devices comprises:
forming a plurality of first anisotropic superconductors over the plurality of openings; and
forming a plurality of second anisotropic superconductors over the seed layer.

75. The method of claim 74, wherein the forming of a plurality of phase shift devices comprises:
forming a plurality of first anisotropic superconductors, having first order parameters with a first orientation; and
forming a plurality of second anisotropic superconductors, having second order parameters with a second orientation, wherein
the first orientation is determined by the first crystal axis orientation; and
the second orientation is determined by the second crystal axis orientation.
